(19) United States
(12) Patent Application Publication
(10) Pub. No.: US 2010/0219376 A1
(43) Pub. Date: Sep. 2, 2010

(54) RED PHOSPHOR MATERIAL AND MANUFACTURING METHOD THEREOF

(75) Inventors: Te-Wen Kuo, Hsinchu (TW); Teng-Ming Chen, Hsinchu (TW)

Correspondence Address: RABIN & Berdo, PC, 1101 14TH STREET, NW, SUITE 500, WASHINGTON, DC, 20005, US

(73) Assignee: LITE-ON IT CORPORATION, Hsinchu (TW)

(21) Appl. No.: 12/473,688

(22) Filed: May 28, 2009

(30) Foreign Application Priority Data
Mar. 2, 2009 (CN) 200910004627.3

(51) Int. Cl. C09K 11/78

(52) U.S. Cl. 252/301.4 R

(57) ABSTRACT

A red phosphor material and a manufacturing method thereof are provided. The red phosphor material is represented by formula A₄(D₁₋ₓEuₓ)B₃O₁₀, wherein, 0<x≦0.6, A is selected from the group consisting of Mg, Ca, Sr, Ba and Zn, and D is selected from the group consisting of rare-earth metals other than Eu.

This application claims the benefit of People's Republic of China application Serial No. 200910004627.3, filed Mar. 2, 2009, the subject matter of which is incorporated herein by reference.

### BACKGROUND OF THE INVENTION

1. Field of the Invention

The invention relates in general to a phosphor material, and more particularly to a red phosphor material and a manufacturing method thereof.

2. Description of the Related Art

The phosphor powder of the FL3 ordinary fluorescent lamp and cold cathode fluorescent lamp which uses spectral line in mercury as the exciting source mixes three colors of phosphor powders including red phosphor powder, green phosphor powder and blue phosphor powder. As known, the red phosphor powder has large influence on the luminous flux and color rendering of the fluorescent lamp. Such red phosphor powder is formed mostly by Y₂O₃:Eu phosphor.

The red phosphor product such as (Y_{0.95}Eu_{0.05})₂O₃, is currently available in the market. However, the phosphor of (Y_{0.95}Eu_{0.05})₂O₃ has large proportion of Y and Eu. As Y and Eu are expensive rare-earth metals, the prices of the phosphor products are totally subjected to the prices of the materials and the cost is hard to be lowered. Thus, how to manufacture a low-cost phosphor material has become an important focus to many manufacturers.

### SUMMARY OF THE INVENTION

The invention is directed to a red phosphor material and a manufacturing method thereof. The red phosphor material provides high luminous intensity by using a small amount of rare-earth metals, hence largely decreasing the cost.

According to a first aspect of the present invention, a red phosphor material is provided. The red phosphor material is represented by formula A₄(D₁₋ₓEuₓ)B₃O₁₀, wherein 0<x≦0.6, A is selected from the group consisting of Mg, Ca, Sr, Ba and Zn, and D is selected from the group consisting of rare-earth metals other than Eu.

According to a second aspect of the present invention, a method of manufacturing red phosphor material is provided. Firstly, a metal salt, an oxide, a boric acid (H₃BO₃) and an europium oxide (Eu₂O₃) are mixed according to a predetermined ratio to form a mixture, wherein, the metal salt comprises element A selected from at least one of the group consisting of Mg, Ca, Sr, Ba and Zn, and the oxide comprises element D selected from at least one of the group consisting of rare-earth metals other than Eu. Next, the mixture is placed in a heating furnace. Then, the mixture inside the heating furnace is sintered according to a predetermined temperature and a predetermined time for generating a red phosphor material which is represented by formula A₄(D₁₋ₓEuₓ)B₃O₁₀, wherein, 0<x≦0.6.

The invention will become apparent from the following detailed description of the preferred but non-limiting embodiments. The following description is made with reference to the accompanying drawings.

### BRIEF DESCRIPTION OF THE DRAWINGS

FIG. 1 shows a flowchart of a method of manufacturing red phosphor material according to a preferred embodiment of the invention;

FIG. 2 shows the X-ray diffraction spectrums of synthesized Ca₄(Y_{0.80}Eu_{0.20})B₃O₁₀ and Ca₄YB₃O₁₀ standard pattern;

FIG. 3 shows a luminous intensity of the light whose main wavelength is 609 nm and is emitted from Ca₄(Y₁₋ₓEuₓ)B₃O₁₀ when being excited by an ultra-velvet light of 254 nm wavelength under different x;

FIG. 4 shows an exciting spectrum of synthesized Ca₄(Y_{0.80}Eu_{0.20})B₃O₁₀; and

FIG. 5 shows the photoluminescence spectrums of the synthesized Ca₄(Y_{0.80}Eu_{0.20})B₃O₁₀ and an ordinary red phosphor product (Y_{0.95}Eu_{0.05})₂O₃.

### DETAILED DESCRIPTION OF THE INVENTION

The present embodiment of the invention provides a new type of red phosphor material. The red phosphor material of the invention is a phosphor material made from boric acid salts for emitting a red light with high intensity by using a small amount of expensive rare-earth metals, hence saving a large amount of cost no matter the phosphor material of the invention is used in optoelectronics or illumination industries. The structure, the application, and the manufacturing method of the red phosphor material of the invention are disclosed below.

The red phosphor material of the present embodiment of the invention is represented by formula A₄(D₁₋ₓEuₓ)B₃O₁₀, wherein 0<x≦0.6, A is selected from the group consisting of Mg, Ca, Sr, Ba and Zn, and D is selected from the group consisting of rare-earth metals other than Eu.

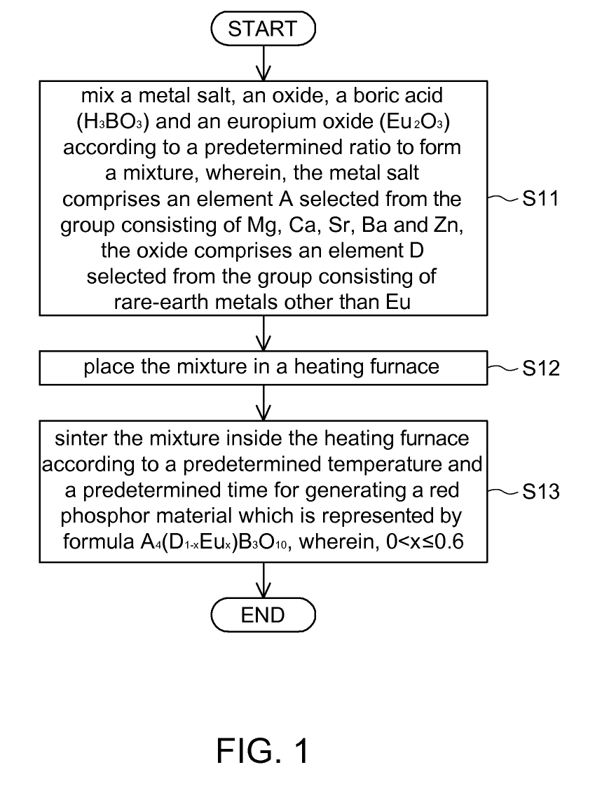

The present embodiment of the invention provides a method of manufacturing red phosphor material. The method comprising steps S11˜S13 is illustrated in FIG. 1.

Firstly, the method begins at step S11, a metal salt, an oxide, a boric acid (H₃BO₃) and an europium oxide (Eu₂O₃) are mixed according to a predetermined ratio to form a mixture. The metal salt comprise element A selected from at least one of the group consisting of Mg, Ca, Sr, Ba and Zn. The oxide comprises element D selected from at least one of the group consisting of rare-earth metals other than Eu. In the manufacturing of the red phosphor material in the present embodiment of the invention, the metal salt is, for example, calcium carbonate (CaCO₃), and the oxide is, for example, yttrium oxide (Y₂O₃).

Next, the method proceeds to step S12, the mixture is placed in a heating furnace.

Then, the method proceeds to step S13, the mixture inside the heating furnace is sintered according to a predetermined temperature and a predetermined time for generating a red phosphor material which is represented by formula A₄(D₁₋ₓEuₓ)B₃O₁₀, wherein, 0<x≦0.6.

In the present embodiment of the invention, the red phosphor material is manufactured according to solid sintering method under high temperature. The manufacturing of Ca₄(Y₁₋ₓEuₓ)B₃O₁₀ is used as an example, and the procedure is elaborated according to the above disclosure.

Firstly, calcium carbonate (CaCO₃), yttrium oxide (Y₂O₃), boric acid (H₃BO₃) and europium oxide (Eu₂O₃) are weighed according to a chemical dosage, and then are mixed and grinded for 10˜30 minutes to form a mixture. The respective weights of calcium carbonate (CaCO₃), yttrium oxide (Y₂O₃), boric acid (H₃BO₃) and europium oxide (Eu₂O₃) are 4, 0.903, 1.854, and 0.352 grams.

Next, the mixture containing calcium carbonate (CaCO₃), yttrium oxide (Y₂O₃), boric acid (H₃BO₃) and europium oxide (Eu₂O₃) is placed in a crucible and then is placed in a high-temperature heating furnace.

Then, the mixture is sintered under a predetermined temperature which is about 1000° C.˜1400° C. for a predetermined time which is about 6-9 hours. In the present embodiment, the predetermined temperature is about 1200° C., and the predetermined time is about 8 hours.

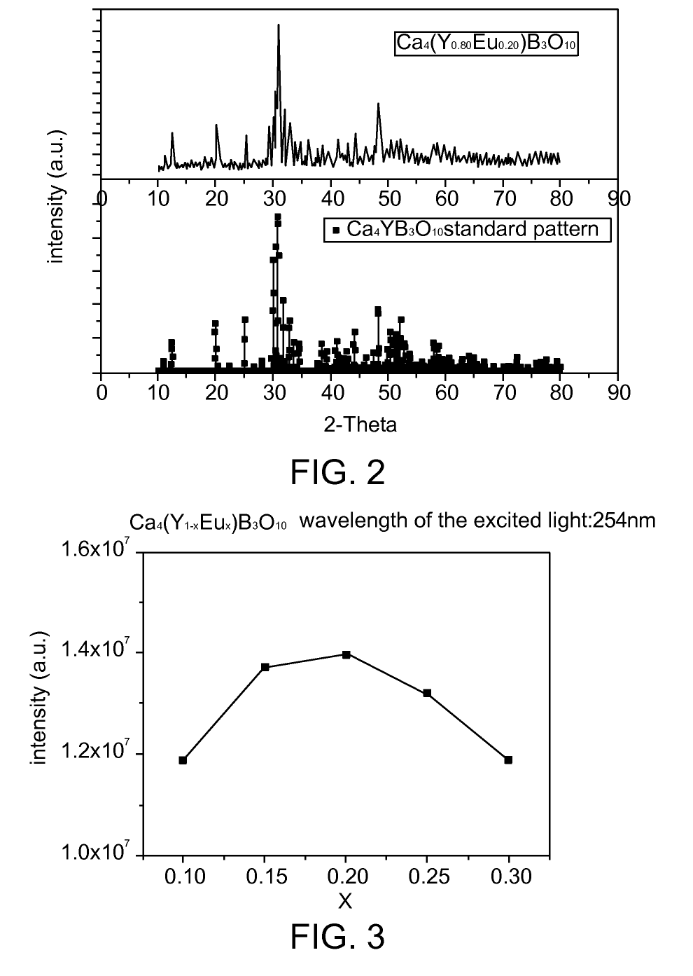

The main wavelength of the light emitted from the red phosphor material of the present embodiment of the invention when being excited is about 595˜615 nm. The red phosphor material synthesized according to the above weight ratio and the sintering conditions of the predetermined temperature and the predetermined time is Ca₄(Y_{0.80}Eu_{0.20})B₃O₁₀, and the X-ray diffraction spectrums of Ca₄(Y_{0.80}Eu_{0.20})B₃O₁₀ and the standard pattern of Ca₄YB₃O₁₀ are shown in FIG. 2.

Also, referring to FIG. 3, a luminous intensity of the light whose main wavelength is 609 nm and is emitted from Ca₄(Y₁₋ₓEuₓ)B₃O₁₀ when being excited by an ultra-velvet light with 254 nm wavelength under different x is shown. As indicated in FIG. 3, when x=0.20, the red phosphor material has excellent luminous intensity. Thus, Ca₄(Y_{0.80}Eu_{0.20})B₃O₁₀ is a preferred implementation of the red phosphor material in the present embodiment of the invention.

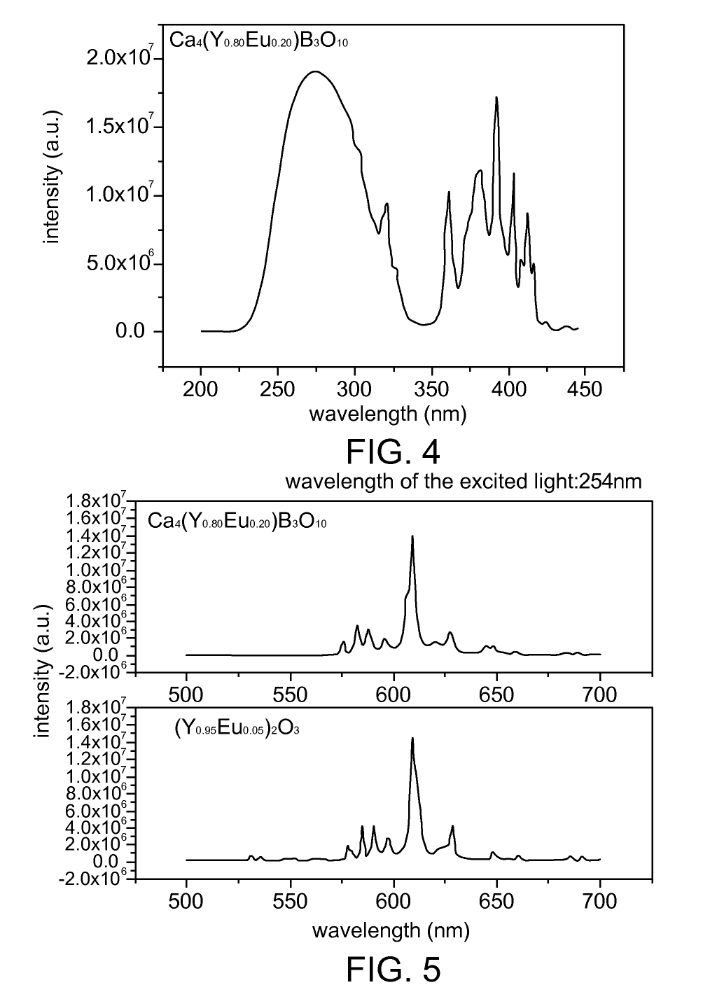

Referring to FIG. 4, an exciting spectrum of synthesized Ca₄(Y_{0.80}Eu_{0.20})B₃O₁₀ is shown. FIG. 4 shows the luminous intensity of the excited light of different wavelengths when the main wavelength of the light is 609 nm. As indicated in FIG. 4, the excited light has superior luminous intensity when the wavelength of the excited light is within the range from 250 to 300 nm or the range from 375 to 425 nm.

Referring to FIG. 5, the photoluminescence spectrums of the synthesized Ca₄(Y_{0.80}Eu_{0.20})B₃O₁₀ and an ordinary red phosphor product (Y_{0.95}Eu_{0.05})₂O₃ are shown. In FIG. 5, both the synthesized Ca₄(Y_{0.80}Eu_{0.20})B₃O₁₀ of the present embodiment of the invention and the ordinary product (Y_{0.95}Eu_{0.05})₂O₃ are excited by an ultra-velvet light with 254 nm wavelength. Also, referring to Table 1, a comparison of CIE chromaticity between (Y_{0.95}Eu_{0.05})₂O₃ and Ca₄(Y_{0.80}Eu_{0.20})B₃O₁₀ in the present embodiment of the invention is illustrated. According to the comparison between the spectrum in the upper diagram and the spectrum in the lower diagram of FIG. 5 as well as the comparison of CIE chromaticity of Table 1, the Ca₄(Y_{0.80}Eu_{0.20})B₃O₁₀ of the present embodiment of the invention indeed has similar illuminating properties like the ordinary product (Y_{0.95}Eu_{0.05})₂O₃, and further provides a red light with high intensity.

TABLE 1

| Red Phosphor Material | CIE Chromaticity x | CIE Chromaticity y |
|---|---|---|
| (Y_{0.95}Eu_{0.05})₂O₃ | 0.64 | 0.35 |
| Ca₄(Y_{0.80}Eu_{0.20})B₃O₁₀ | 0.64 | 0.35 |

As the ordinary product (Y_{0.95}Eu_{0.05})₂O₃ contains large proportion of rare-earth metals Y and Eu, the product price of (Y_{0.95}Eu_{0.05})₂O₃ is totally subjected to the prices of the rare-earth metals. In the present embodiment of the invention, the red phosphor material Ca₄(Y₁₋ₓEuₓ)B₃O₁₀ contains elements other than rare-earth metals, so the red phosphor material can be manufactured by using a small amount of Y and Eu but still emits red light with high intensity. Therefore, the red phosphor material of the invention has the advantages of low cost and can further be used in other devices.

The red phosphor material Ca₄(Y₁₋ₓEuₓ)B₃O₁₀ of the present embodiment of the invention can be used in different illuminating devices and work with a light source exciting element. The light source exciting element can be an ultra-velvet light source such as a low-pressure mercury (vapor) discharge lamp, such that the main wavelength of the light emitted from the red phosphor material when being excited by the ultra-velvet light is about 595˜615 nm. The illuminating devices can be compact fluorescent lamp (CFL), hot cathode fluorescent lamp (HCFL) or cold cathode fluorescent lamp (CCFL).

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A red phosphor material represented by formula A₄(D₁₋ₓEuₓ)B₃O₁₀, wherein 0<x≦0.6, A is selected from the group consisting of Mg, Ca, Sr, Ba and Zn, and D is selected from the group consisting of rare-earth metals other than Eu.

2. The red phosphor material according to claim 1, wherein the main wavelength of the light emitted from the red phosphor material is about 595˜615 nm.

3. The red phosphor material according to claim 1 being Ca₄(Y_{0.80}Eu_{0.20})B₃O₁₀, wherein when the red phosphor material is excited by a 254 nm ultra-velvet light, the main wavelength of the light emitted from the red phosphor material is about 609 nm.

4. The red phosphor material according to claim 1, wherein element A is selected from at least one element of the group consisting of Mg, Ca, Sr, Ba and Zn.

5. The red phosphor material according to claim 1, wherein element D is selected from at least one element of the group consisting of the group consisting of rare-earth metals other than Eu.

6. A method of manufacturing red phosphor material, the method comprising:
mixing a metal salt, an oxide, a boric acid (H₃BO₃) and an europium oxide (Eu₂O₃) according to a predetermined ratio to form a mixture, wherein, the metal salt comprises an element A selected from the group consisting of Mg, Ca, Sr, Ba and Zn, the oxide comprises an element D selected from the group consisting of rare-earth metals other than Eu;
placing the mixture in a heating furnace; and
sintering the mixture inside the heating furnace according to a predetermined temperature and a predetermined time for generating a red phosphor material which is represented by formula A₄(D₁₋ₓEuₓ)B₃O₁₀, wherein, 0<x≦0.6.

7. The manufacturing method according to claim 6, wherein element A is selected from at least one element of the group consisting of Mg, Ca, Sr, Ba and Zn.

8. The manufacturing method according to claim 6, wherein element D is selected from at least one element of the group consisting of the group consisting of rare-earth metals other than Eu.

9. The manufacturing method according to claim 6, wherein, the predetermined temperature is about 1000° C.˜1400° C.

10. The manufacturing method according to claim 6, wherein, the predetermined time is about 6˜9 hours.
